(19) United States
(12) Patent Application Publication
(10) Pub. No.: US 2013/0214101 A1
(43) Pub. Date: Aug. 22, 2013

(54) ATTACHABLE GATHERING BRACKET FOR RETAINING ANY NUMBER OF HOSES, SUCH AS ASSOCIATED WITH AN INJECTION MOLDING OPERATION

(71) Applicant: Kevin M. Daniel, Grant Township, MI (US)

(72) Inventor: Kevin M. Daniel, Grant Township, MI (US)

(21) Appl. No.: 13/770,558

(22) Filed: Feb. 19, 2013

Related U.S. Application Data
(60) Provisional application No. 61/599,462, filed on Feb. 16, 2012.

(51) Int. Cl. F16L 3/02

(52) U.S. Cl. CPC F16L 3/02
USPC 248/75

(57) ABSTRACT

A bracket for gathering and retaining flexible conduits and including a superstructure having an upper frame and lower extending stem. A pedestal seating the stem so that the frame is supported thereupon, with an underside of the pedestal adhering to a location associated with an application to which the conduits are related and in order to prevent bending or kinking of the hoses.

### CROSS-REFERENCE TO RELATED APPLICATIONS

This Application claims the benefit of U.S. Provisional Application 61/599,462 filed on Feb. 16, 2012, the contents of which are incorporated herein in its entirety.

### FIELD OF THE INVENTION

The present application is directed to a gathering bracket, such as including a magnetically attracting pedestal or base suitable for adhering to an opposite polarity/attracting magnetic surface associated with an injection molding or other machine, to which are associated any number of individual elongated hoses or conduits, such as including but not limited to fluid carrying or electrical wiring conduits. The bracket includes an upper frame with an open interior through which the hoses are inserted in such as fashion as to prevent them from being kinked or pinched.

### BACKGROUND OF THE INVENTION

The prior art is documented with various examples of cable holding and routing devices. A first example of this is set forth in U.S. Pat. No. 8,052,098, to Kowalski, and which teaches a cable holding device including a body for holding the cables, a mounting bracket for mounting such as to a roof, and an arm that serves to extend the body beyond a terminal edge of the roof, allowing the cables to be draped over the edge of a building without touching the terminal edge of the roof.

U.S. Publication No. 2010/0019104 to Ichimura teaches a hydraulic hose guide allowing hydraulic hoses to be connected to an operational pattern switching valve in a construction machine. The hoses are led through a clearance between an operator's cab disposed on an upper revolving superstructure and a cooler chamber of a hydraulic power unit. A guide member is disposed between the an operator's cab and the cooler chamber and holds the hoses in place to prevent their displacement towards the cooler chamber.

Amundson, U.S. 2009/0294603, discloses a quick release hose guide attachable to a work machine. A sleeve slides over a post on the work machine when hydraulic hoses of an attachment are connected to the hydraulic system of the machine. A quick release pin is inserted through apertures in the sleeve and in the post to secure the hose guide in place. A snap clip is connected to the pin to retain the pin in place.

### SUMMARY OF THE INVENTION

The present invention discloses a bracket for gathering and retaining any number of flexible conduits, including a superstructure having an upper frame and lower extending stem. A pedestal seats the stem so that the frame is supported thereupon, with an underside of the pedestal adhering to a location associated with an application to which the conduits are related and in order to prevent bending or kinking of the hoses.

Additional features include the upper frame exhibiting a multi-sided perimeter extending portion including at least a rectangular shape and so as to define an open interior through which any number of flexible conduits are routed. The superstructure exhibits a specified shape and size and is constructed of any suitable material, such as including a lightweight metal or a hard plastic body.

The superstructure may further exhibit a vertically extending channel extending upwardly from an underside communicating location of the stem. A receptacle can be defined in in the superstructure in communication with the vertically extending channel, a nut seating within the receptacle such that an interiorly threaded pattern associated with said nut is in alignment with the channel for receiving an exteriorly threaded shaft of an underside inserted fastener supported within the pedestal.

The superstructure may further incorporate rib supports surrounding the nut receiving and integrally formed receptacle. A disk shaped magnet can be seated within the pedestal and secured against an interior surface. The superstructure can further exhibit either of a linear vertical or angled construction to space the frame relative to the pedestal.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of the gathering bracket device according to a first preferred embodiment and exhibiting an upper perimeter frame retaining portion and a lower magnetic attaching portion;

FIG. 2 is a top view of the device shown in FIG. 1;

FIG. 3 is a side view of the device shown in FIG. 1;

FIG. 4 is a front view of the device shown in FIG. 1;

FIG. 5 is a bottom view of the device shown in FIG. 1;

FIG. 6 is a planar cutaway of the device in FIG. 1 and better illustrating the interior configuration of the device including the pedestal located magnet and the screw mounted upper extending superstructure secured atop the pedestal and including the open interior defining frame;

FIG. 7 is an exploded view of the bracket in FIG. 1;

FIG. 8 is a perspective illustration of the gathering bracket device according to a second preferred embodiment and which exhibits an upper perimeter frame retaining portion arranged at an offset angle along with a lower magnetic attaching portion;

FIG. 9 is a top view of the device shown in FIG. 8;

FIG. 10 is a side view of the device shown in FIG. 8;

FIG. 11 is a front view of the device shown in FIG. 8;

FIG. 12 is a bottom view of the device shown in FIG. 8;

FIG. 13 is a planar cutaway of the device in FIG. 8 and better illustrating the interior configuration of the device including the pedestal located magnet and the screw mounted upper angular extending superstructure secured atop the pedestal and including the open interior defining frame; and

FIG. 14 is an exploded view of the bracket in FIG. 8.

### DETAILED DESCRIPTION OF THE PREFERRED EMBODIMENTS

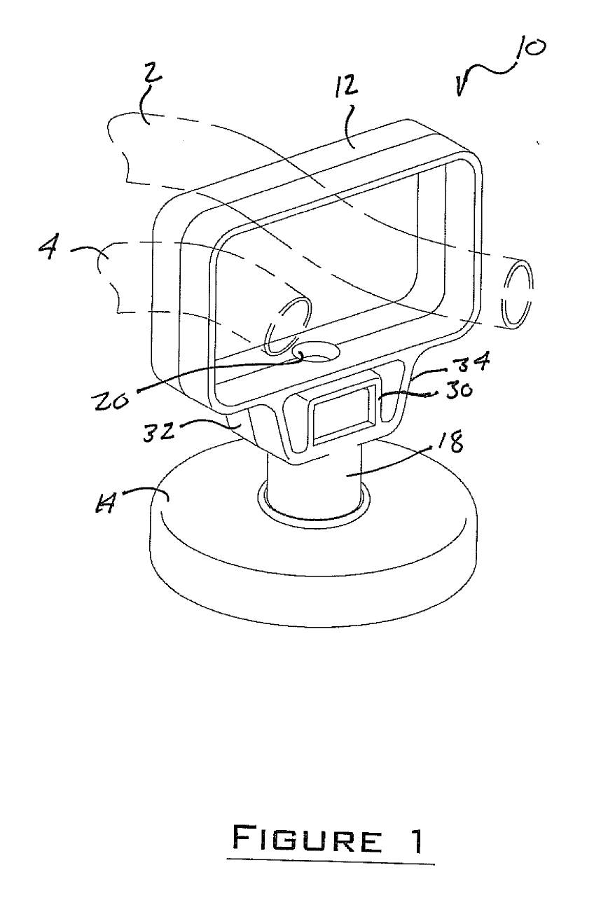

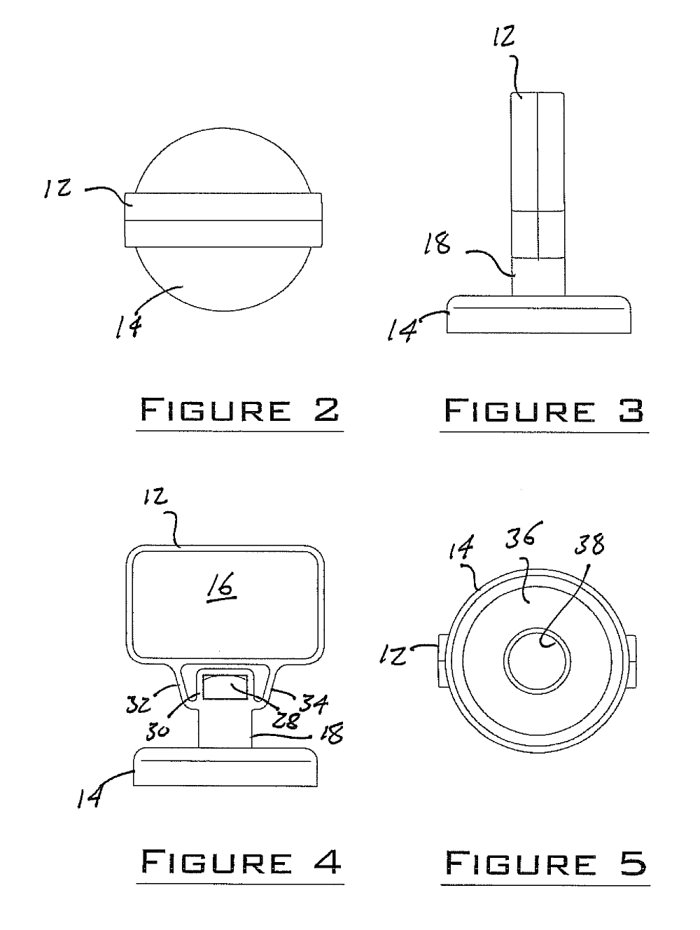

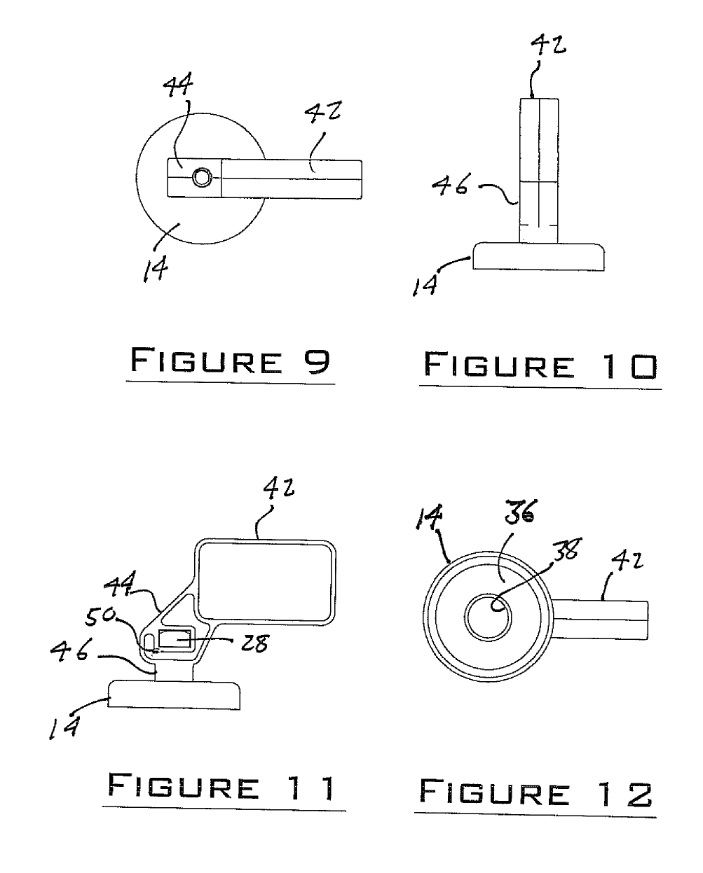

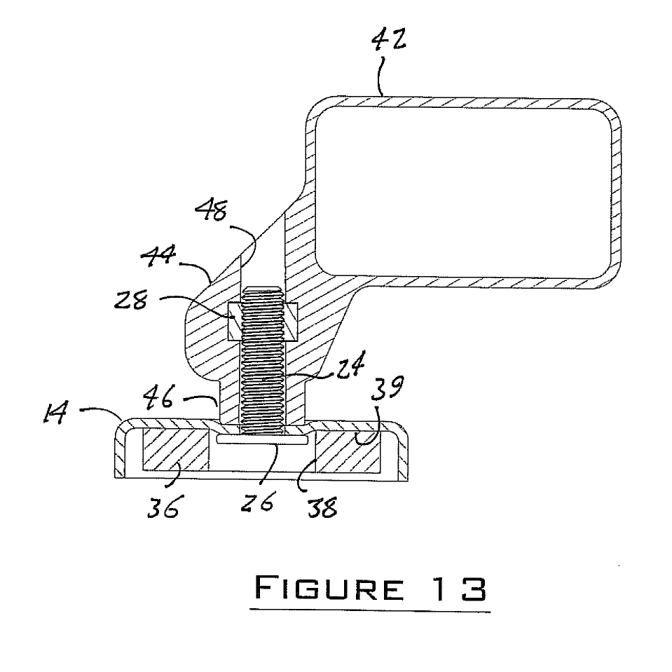

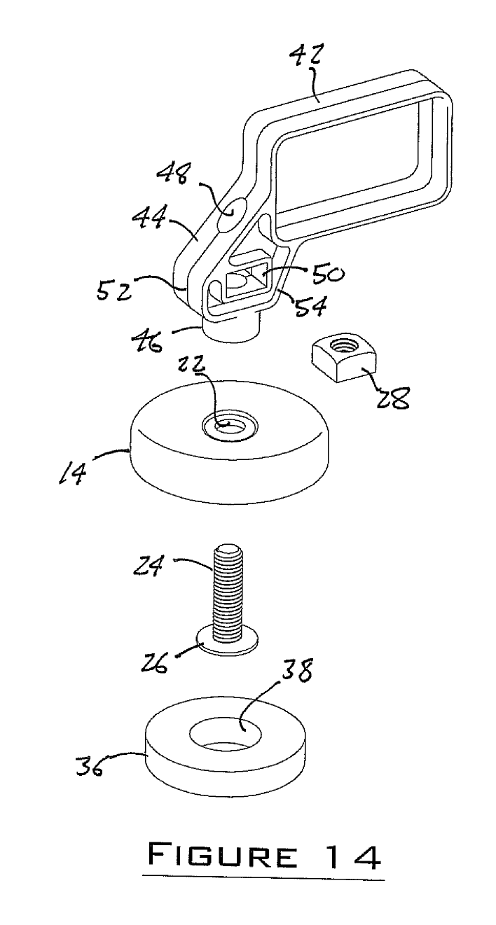

As will be described with reference to the embodiments respectively depicted in FIGS. 1-7 and 8-14, the present application discloses a hose gathering bracket or harness type device. As previously described, the purpose of the bracket is again to assist in gathering and securing extending lengths of any number of conduit or flexible hoses, such as including but not limited to the electrical or fluid (pneumatic, hydraulic, etc.) variety.

As will be further described in additional detail, the gathering devices disclosed herein can be used either singularly or in plural (kit) form and in order to restrain bunches of conduits associated with a myriad of applications not limited to industrial/manufacturing facilities, large passenger vessels, vehicles or any other application in which it is desirous to segregate and locate one or more such conduits in order to prevent damage thereto as well as potential harm to proximately located individuals.

Specifically, the gathering bracket design is effectively employed anywhere that there is a need for temporary or flexible configurations to route cooling, heating, paint, oil, communication, hydraulic and/or power supply lines. This can further include, without limitation, application to any conventionally known manufacturing or processing assembly or system, such as any of injection molding, extrusion, stamping, machining or painting.

Other applications include agricultural related applications, notably relating to farm implements and livestock care. Construction related applications can include any of new building construction, insurance repair (e.g. routing of temporary lighting and power supply) as well as tunnel excavation.

As further previously described, a known problem involves the kinking and/or bending which can attend the arrangement of a large number of hoses associated with injection molding or other mold formation or other processing equipment which requires any number of conduit lines. The present invention, as further described below, seeks to remedy that problem, such as in one non-limiting application through the provision of a device where polar opposite magnetic field generating surfaces established between the underlying metal surface and magnetic underside of the bracket facilitate the attachment of the bracket device in a convenient and easily repositionable fashion along the metallic/magnetic inducing surfaces of the intended application.

In view of the above, FIG. 1 is a perspective illustration, generally at 10, of the gathering bracket device according to a first preferred embodiment and which includes an upper perimeter or frame defining portion 12 which is supported upon a circular pedestal 14 (the shaping of the pedestal further understood to not be limited to any particular profile). The frame defining portion 12, as depicted, includes a multi-sided perimeter extending portion, such as depicted as rectangular shaped, to define an open interior 16 through which any number of flexible conduits 2, 4, et. seq. are routed.

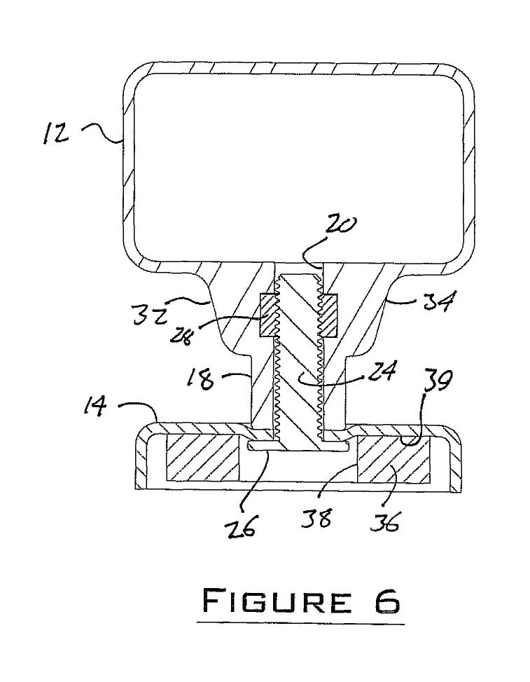

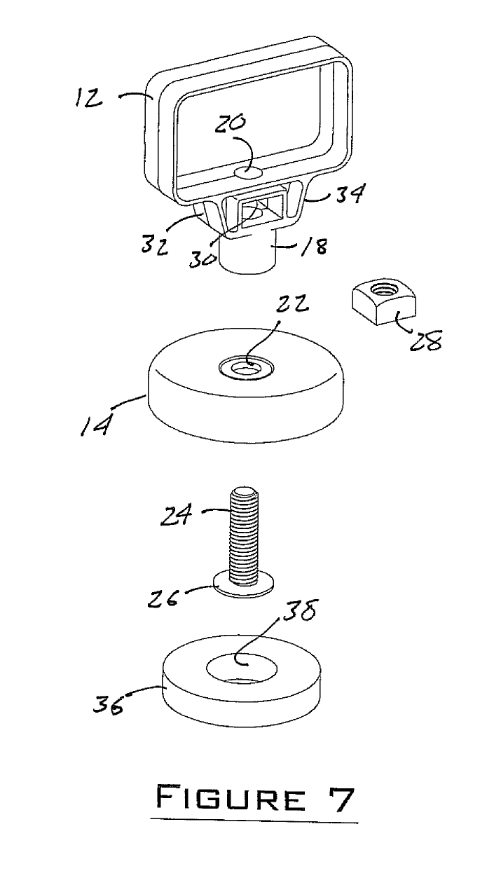

As additionally depicted in the exploded view of FIG. 7, the upper frame portion 12 can be constructed of any suitable material, such as including a lightweight metal or a hard plastic body. An underside stein support 18 is integrally formed with the frame defining portion 12 and, as further shown in the cutaway view of FIG. 6, includes exhibits an underside communicating and vertically extending interior or channel defined by an inner surface 20.

The pedestal 14 is again depicted with a circular profile and includes an inner aperture defined by an inner extending rim surface 22, through which is seated a threaded shaft 24 of an underside inserting fastener (see fastener head 26). As best depicted in FIGS. 6-7, a nut 28 is seated within a multi sided receptacle 30 integrated into the stem 18.

As shown, the receptacle 30 includes a series of interconnected surfaces collectively exhibiting an enlarge rectangular seating profile for receiving the nut 28 in an open inserting fashion. The receptacle 30 is integrally formed into the underlying structure of the frame defining portion 12 such that an interiorly threaded pattern associated with the inserted nut 28 is arranged in alignment with the inner channel 20 and is in alignment with the inner rim surface defined aperture 22 defined in the pedestal 14 (see again as best shown in lengthwise cutaway of FIG. 6).

In this fashion, and as again best shown in the cutaway view of FIG. 6, the underside inserted fastener 26 is installed through the base 14 in such a manner as to extend upwardly through the inner aperture 22 of the pedestal 14 and the aligning channel 20 of the underside stem support 18 integrated with the nut receptacle 30 and upper frame portion 12. Rotation of the fastener 26 causes the threads on shaft 24 to be rotationally and threadably engaged with the inner threaded profile associated with the nut 28, again upon the same being prepositioned in seating fashion within the receptacle location 30 defined in an underside superstructure (see also rib supports 32 and 34) separating the upper frame 12 from the lower integrated stem 18.

A disk shaped magnet 36 (or other suitable shaped magnet depending upon the choice of design of the pedestal) is provided and which is dimensioned as depicted to include a likewise circular outer perimeter with an inner aperture configured by an inner perimeter wall 38. In this fashion, the magnet 36 is received within a hollow underside interior of the pedestal 14 (see again FIG. 6) and so that the magnet 36 is affixed or otherwise adhered by natural attraction to an inner ceiling 39 of the pedestal 14.

In use, and upon positioning the pedestal 14 atop a magnetic surface such as is commonly associated with an injection molding housing, an opposite polarity/attracting magnetic field is established with the underlying magnetic surface of the mold (not shown). This permits the bracket device to be quickly and easily repositioned to varying magnetic supporting locations along the mold or other assembly for quickly and efficiently gathering any number of hoses 2, 4, et seq. (as shown in FIG. 1) capable of being channeled through the open inner perimeter created by the frame defining portion 12. In this fashion, a plurality of bracket devices 10 can be effectively employed in spaced apart fashion to better manage the pluralities of conduits associated with the machine.

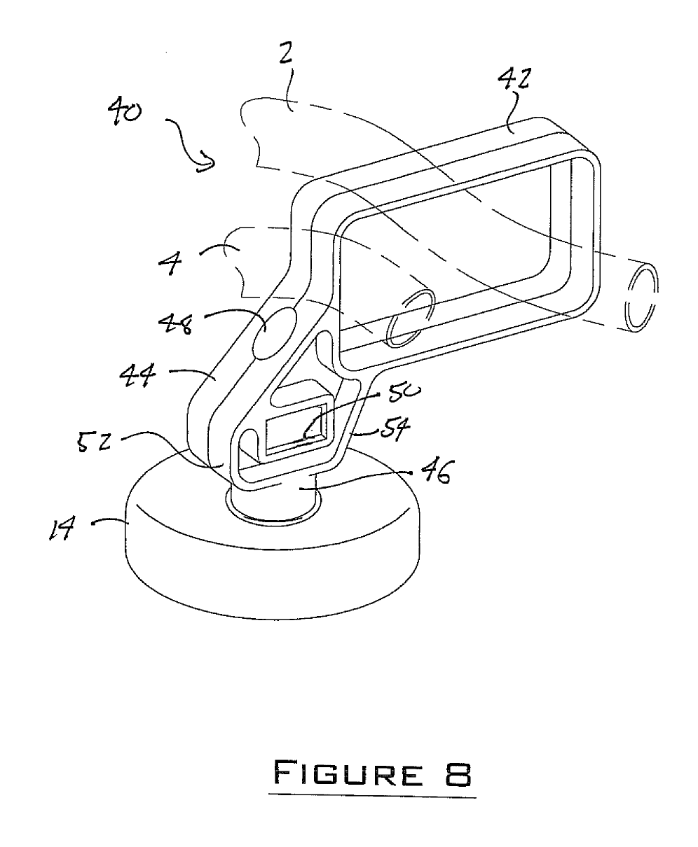

FIGS. 8-14 depict, generally at 40 as best shown in FIG. 8, a variation of the conduit gathering and supporting bracket which is substantially the same as depicted collectively in FIGS. 1-7, with the exception that it provides a redesigned frame 42 with an angled superstructure 44 as opposed to the linear vertical configuration of the frame 12 in the first depicted variant. Otherwise, the frame 42 and underlying superstructure 44 operate both structurally and functionally the same as previously described and in which an underside stem support 46 is integrally formed with the frame defining portion 12 and, as further shown at 48, includes exhibits an underside communicating and vertically extending interior or channel.

The pedestal 14 is as depicted previously depicted in FIGS. 1-7 and again includes a circular profile and includes an inner aperture 22 through which is seated a threaded shaft 24 of an underside inserting fastener (see fastener head 26). A nut 28 is again seated within a multi sided and open inserting receptacle 50 which is integrally formed into the underlying structure of the frame defining portion 42 and is communicable with the inner aperture 48.

In this fashion, the underside inserted fastener 26 is installed through the base 14 in such a manner as to extend upwardly through the inner aperture 48 of the upper angular extending frame portion 42 and to be rotationally and threadably engaged with the inner threaded profile associated with the nut 28 upon the same be prepositioned in seating fashion within the receptacle location 50 defined in an underside superstructure (see also provided rib supports 52 and 54 which are similar to those previously disclosed at 32 and 34 in the variant of FIGS. 1-7) separating the upper frame 42 from the lower stem 46.

It is envisioned and understood that the brackets may be redesigned beyond those shown and such as to include the ability to be repositionable, such further contemplating the supporting stem incorporating any form of resistance adjustable bearing or eccentric support. Other shapes, materials and configurations are further envisioned consistent with the functional and applicational advantages of the designs as described herein. It is also envisioned that the gathering brackets described herein can also be employed in other conduit restraining applications different from those discussed and without departing from the scope of the invention.

Additional to the illustrated embodiment of the gathering bracket device as described, other and additional related variants are contemplated and which can include producing the body using an insert molding or like suitable process, and as an alternative to the nut and bolt assembly described and shown. In such an alternate application, the nut and bolt can be eliminated and the magnet held in place such as with plastic only. Another possible variation of the invention includes reconfiguring the conduit retraining frames 12 or 42, such as to integrate a hinged clasp or even opposing deformably resilient portions, such permitting access to the interior of the frame for installing or removing cables, this without having to pull the entire length of the cable through the frame opening.

Having described my invention, other and additional preferred embodiments will become apparent to those skilled in the art to which it pertains, and without deviating from the scope of the appended claims.

I claim:

1. A bracket for gathering and retaining any number of flexible conduits, comprising:
a superstructure including an upper frame and lower extending stem;
a pedestal seating said stem so that said frame is supported thereupon; and
an underside of said pedestal adhering to a location associated with an application to which the conduits are related and in order to prevent bending or kinking thereof

2. The bracket as described in claim 1, said upper frame further comprising a multi-sided perimeter extending portion including at least a rectangular shape and so as to define an open interior through which any number of the flexible conduits are routed.

3. The bracket as described in claim 1, further comprising said superstructure having a specified shape and size and being constructed of any suitable material, such as including a lightweight metal or a hard plastic.

4. The bracket as described in claim 1, said superstructure further comprising a vertically extending channel extending upwardly from an underside communicating location of said stem.

5. The bracket as described in claim 4, further comprising a receptacle defined in said superstructure in communication with said vertically extending channel, a nut seating within said receptacle such that an interiorly threaded pattern associated with said nut is in alignment with said channel for receiving an exteriorly threaded shaft of an underside inserted fastener supported within said pedestal.

6. The bracket as described in claim 5, said superstructure further comprising rib supports surrounding said nut receiving and integrally formed receptacle.

7. The bracket as described in claim 1, further comprising a magnet seated within said pedestal and securing against an interior surface.

8. The bracket as described in claim 1, further comprising said superstructure exhibiting either of a linear vertical or angled construction to space said frame relative to said pedestal.

9. A bracket for gathering and retaining any number of flexible conduits, comprising:
a superstructure including an upper frame exhibiting a multi-sided perimeter opening, a stem extending downwardly from said frame and terminating in a pedestal support; and
a magnet seating within said pedestal and establishing an attraction to a metallic support surface associated with an installation location to which the conduits are related and in order to prevent bending or kinking of thereof.

10. The bracket as described in claim 9, further comprising said superstructure having a specified shape and size and being constructed of any suitable material, such as including a lightweight metal or a hard plastic.

11. The bracket as described in claim 9, said superstructure further comprising a vertically extending channel extending upwardly from an underside communicating location of said stem.

12. The bracket as described in claim 11, further comprising a receptacle defined in said superstructure in communication with said vertically extending channel, a nut seating within said receptacle such that an interiorly threaded pattern associated with said nut is in alignment with said channel for receiving an exteriorly threaded shaft of an underside inserted fastener supported within said pedestal.

13. The bracket as described in claim 12, said superstructure further comprising rib supports surrounding said nut receiving and integrally formed receptacle.

14. The bracket as described in claim 9, further comprising a magnet seated within said pedestal and securing against an interior surface.

15. The bracket as described in claim 9, further comprising said superstructure exhibiting either of a linear vertical or angled construction to space said frame relative to said pedestal.

16. A bracket for gathering and retaining any number of flexible conduits, comprising:
a superstructure including an upper frame exhibiting a multi-sided perimeter opening, a stem extending downwardly from said frame and terminating in a pedestal support;
a vertically extending channel extending upwardly within said superstructure from an underside communicating location of said stem and pedestal support;
a receptacle defined in said superstructure in communication with said vertically extending channel, a nut seating within said receptacle such that an interiorly threaded pattern associated with said nut is in alignment with said channel for receiving an exteriorly threaded shaft of an underside inserted fastener supported within said pedestal; and
a magnet seating within said pedestal and establishing an attraction to a metallic support surface associated with an installation location to which the conduits are related and in order to prevent bending or kinking of thereof.

17. The bracket as described in claim 16, further comprising said superstructure having a specified shape and size and being constructed of any suitable material, such as including a lightweight metal or a hard plastic.

18. The bracket as described in claim 16, said superstructure further comprising rib supports surrounding said nut receiving and integrally formed receptacle.

19. The bracket as described in claim 16, further comprising said superstructure exhibiting either of a linear vertical or angled construction to space said frame relative to said pedestal.

20. The bracket as described in claim 16, said multi-sided perimeter extending portion including at least a rectangular shape.
